(19) United States
(12) Patent Application Publication
(10) Pub. No.: US 2023/0050924 A1
(43) Pub. Date: Feb. 16, 2023

(54) System for Dissemination of Sensitive Information

(71) Applicant: Henry L. Bolton, Fernandina Beach, FL (US)

(72) Inventor: Henry L. Bolton, Fernandina Beach, FL (US)

(21) Appl. No.: 17/888,173

(22) Filed: Aug. 15, 2022

Related U.S. Application Data
(60) Provisional application No. 63/232,649, filed on Aug. 13, 2021.

(51) Int. Cl. G06F 21/62; G06F 16/11; G06Q 40/00

(52) U.S. Cl. CPC G06F 21/6245; G06F 16/113; G06Q 40/123

(57) ABSTRACT

The present disclosure provides a system for disseminating sensitive information. The system includes a software application which comprises a mobile application installed on a mobile device that enables a user to capture images, via a camera provided by the mobile device, of one or more documents which can then be subsequently uploaded to a remote database. The software application may also include a web-based application. The software application comprises a document checklist, document validation module, and an external communication module. After the electronic files are uploaded to the remote database the user may utilize the document validation module to cross-reference certain personal information is consistently disclosed within each of the one or more documents. The external communication module is configured to allow the user to select one or more electronic files from the remote database and electronically transmit the selected files to another party via an electronic facsimile (E-Fax).

### CROSS-REFERENCE TO RELATED APPLICATIONS

This application claims the benefit of U.S. Provisional Application No. 63/232,649, filed Aug. 13, 2021, which is hereby incorporated by reference in its entirety for all purposes.

### FIELD OF THE INVENTION

The present invention comprises a system for disseminating sensitive information. The system for disseminating sensitive information is generally related to mobile applications which assist with the aggregation and dissemination of one or more types of data.

### BACKGROUND

Each year hundreds of thousands of U.S. individuals are audited. An auditor often require a variety of documents and information to be submitted for review. Being audited can be a stressful process for the individual being audited. The auditor typically notifies the individual being audited with a notice letter. The notice letter includes general information about the audit, what information is being requested, and how to submit the requested information. However, if the notice letter is misplaced or if the individual being audited does not carefully and thoroughly review the standardized letter the audit process can become unnecessarily extended and result in additional costs to the individual being audited. Accordingly, what is needed is a system which allows individuals being audited to conveniently aggregate copies of various documents and paperwork which are typically requested during the audit process.

### BRIEF SUMMARY OF THE INVENTION

The present disclosure describes a system for disseminating sensitive information. The system comprises a software application, a mobile device, a network, a remote database, and one or more documents. The one or more documents may contain sensitive personal information. The software application, which comprises a mobile application and, optionally, a web-based application. The software application further comprises a document checklist, a document validation module, and an external communication module. The software application is configured to enable a user to upload one or more electronic files to the remote database. The one or more electronic files may also include the user's tax return from one or more prior years. The one or more electronic files may comprise a variety of file types, including image files. The external communication module is configured to allow a user to conveniently select one or more electronic files which have been uploaded to the remote databased and electronically transmit the selected electronic files to another party. It is anticipated that the software application may be further configured to allow the user to optionally convert one or more types of electronic files into a portable document format (PDF).

The mobile application is installed on the mobile device, which includes a camera, and is configured to allow the user to access the camera to capture one or more image files of the one or more documents and then upload one or more image files to the remote database. It is anticipated that the software application may automatically create duplicates of each of the uploaded electronic files and then subsequently convert each duplicate file into a text-readable file.

The document checklist provides a list of one or more predetermined documents that pertain to information requested within the notice letter that the user received from an auditor. The document checklist includes a visual indicator adjacent to each of the one or more documents and visually signifies if the corresponding document has been properly uploaded to the remote database. The document validation module is configured to confirm if an electronic copy of each of the one or more documents enumerated in the document checklist have been uploaded to the remote database. The external communication module is configured to transmit one or more reminder notifications to the user if one or more electronic copies of the one or more documents have not been uploaded by a predetermined date. It is anticipated that the document validation module may be configured to cross-reference if certain sensitive personal information is consistently disclosed within each of the one or more electronic files uploaded to the remote database. The external communication module allows the user to electronically transmit, via email or electronic facsimile (E-Fax), one or more of the one or more electronic files to one or more other parties.

### BRIEF DESCRIPTION OF THE DRAWINGS

FIG. 1 is a schematic diagram of a system for disseminating sensitive information.

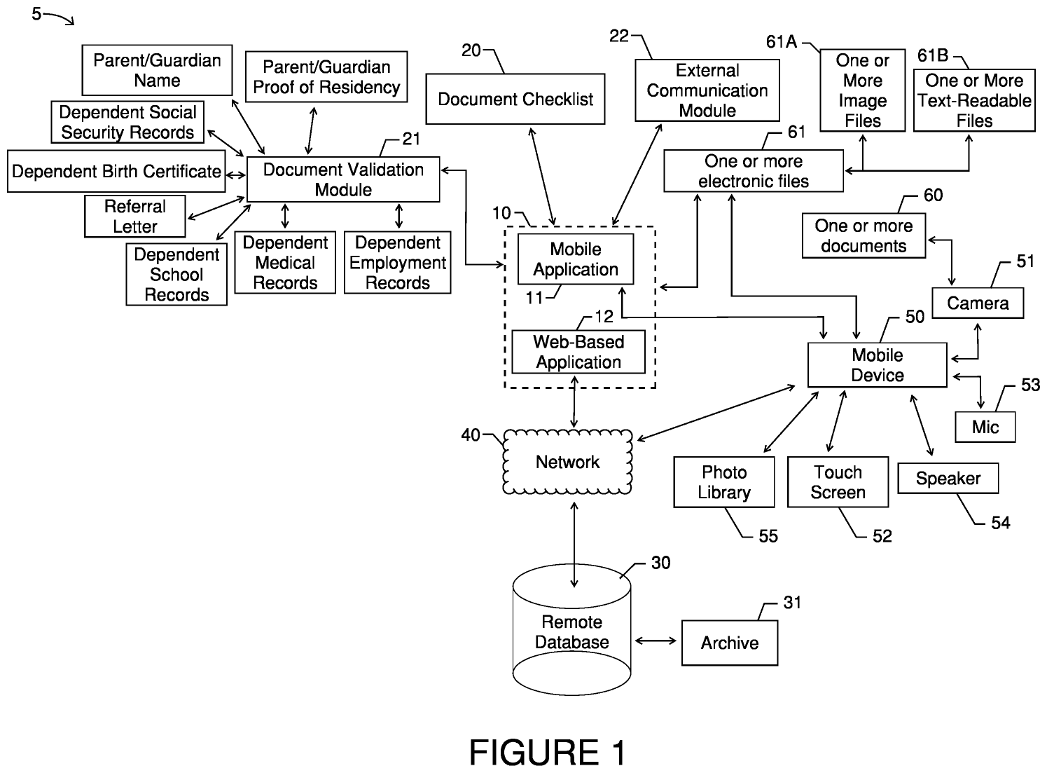

FIG. 2 is a schematic flowchart illustrating how a user of the system for disseminating sensitive information accesses their respective user account.

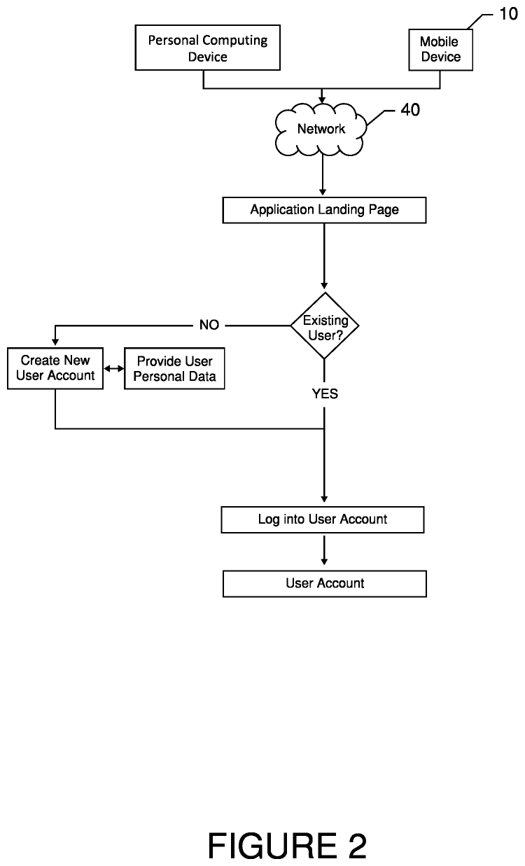

FIG. 3 is a schematic diagram of a user account provided by the system for disseminating sensitive information.

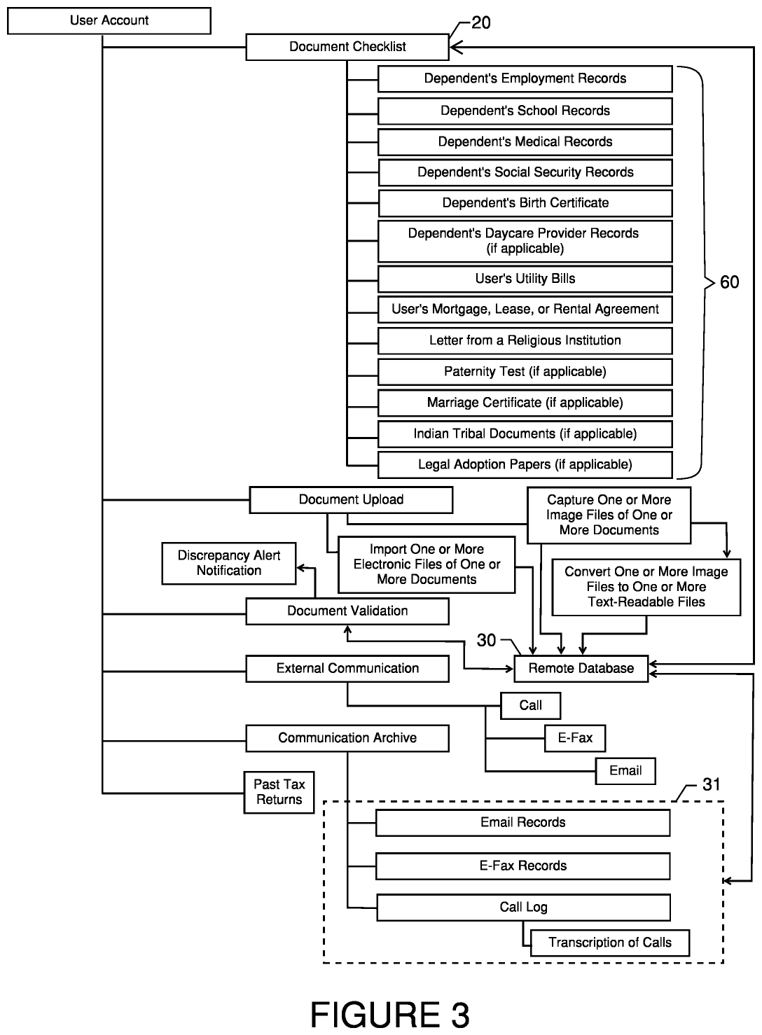

### NUMBERING REFERENCE

5—System for disseminating sensitive information
10—Software application
11—Mobile application
12—Web-based application
20—Document checklist
21—Document validation module
22—External communication module
30—Remote database
40—Network
50—Mobile device
51—Camera
52—Touch screen
53—Mic
54—Speaker
55—Photo library
60—One or more documents
61—One or more electronic files
61A—One or more image files
61B—One or more text-readable files

### DETAILED DESCRIPTION OF THE EMBODIMENTS

The present disclosure describes a system for disseminating sensitive information 5. The system for disseminating sensitive information 5, hereinafter referred to as the “dissemination system” 5, includes a software application 10, a remote database 30, a network 40, a mobile device 50, and one or more documents 60. The software application 10 comprises a mobile application 11 and, optionally, a web-based application 12. The mobile device 50 is configured to wirelessly connect to the network 40 and provides a camera 51, a touch screen 52, a speaker 53, a mic 54, and a photo library 55. The software application 10 enables a user to efficiently compile, validate, and electronically transmit electronic copies of one or more documents 60, via email or electronic facsimile (E-Fax), to another party, such as, but not limited to, a corporate entity or a government agency, who may or may not be a user of the dissemination system 5.

The software application 10 provides a user account for each user. Each user must log into their user account with unique user credentials. User credentials preferably comprise a username and password. However, it is anticipated that user credentials could alternatively comprise biometric authentication. If the user accesses their respective user account on their mobile device 50, the mobile application 11 allows the user to access the camera 51, or the photo library 55, while the user is logged into their respective user account.

The software application 10 includes a document checklist 20, a document validation module 21, and an external communication module 22. The document checklist 20 comprises a predetermined list of one or more documents 60 that the user will need to create electronic copies of and, subsequently, upload to the remote database 30. The one or more documents 60 include a combination of permanent documents and one or more temporary documents.

Permanent documents include a social security card for the user and the claimed dependent as well as a birth certificate for the user and the claimed dependent. Temporary documents may include one or more of the following: employment records of the claimed dependent, school records of the claimed dependent (such, but not limited to, as a 1098T form or a transcript), medical records of the claimed dependent, records related to the daycare provider of the claimed dependent, documents which establish proof of residency of the user (such as a utility bill, a mortgage note or a lease agreement), a letter from a religious institution verifying the user's relationship with the claimed dependent, a paternity test evidencing a paternal relationship between the user and the claimed dependent, a marriage certificate, adoption paperwork, or Native American tribal documents. Additionally, the one or more documents 60 may also include the notice letter which the user received from the auditing party.

It is anticipated that the software application 10 may be configured to analyze the notice letter if it is uploaded to the remote database 30 and determine which documents the user needs to upload as well as the phone number, email address, or fax number which the notice letter identifies for future correspondence related to the audit. As an example, it is not uncommon for an audit to pertain to an individual's tax return, particularly if the individual claimed a dependency exemption on their tax return. In such an audit, the individual being audited typically must prove he or she lived with the dependent for more than half of the tax year, verify how he or she is related to the claimed dependent, as well as satisfaction of several other requirements established by the Internal Revenue Service (“IRS”).

The mobile application 11 allows the user to access the camera 51 to capture one or more image files 61A of the one or more documents 60 and upload each of the one or more image files 61A to the remote database 30. Alternatively, if the user already has an electronic copy of one or more of the one or more documents 60, the software application 10 is configured to allow the user to select one or more locally stored electronic files and upload the selected files to the remote database 30. The document checklist 20 is configured to display a visual icon adjacent to each document listed in the document checklist 20 to indicate whether an electronic copy of the particular document has been uploaded. Additionally, the document checklist 20 also includes descriptive information regarding each of the one or more documents 60. It is anticipated that the document checklist 20 may optionally provide one or more example files of each document enumerated in the document checklist 20 for the user to view for further clarification.

The software application 10 is configured to utilize an optical character recognition (OCR) process to create one or more text-readable files 61B of each electronic file uploaded to the remote database 30. Subsequently, the software application 10 is configured to utilize the document validation module 21 to search and cross-reference the one or more text-readable files 61B with one another to validate certain sensitive personal information, such as the residency of the user and dependent, is consistently disclosed within each of the one or more documents 60. The document validation module 21 may be configured to cross-reference the one or more text-readable files 61B for identifying information of more than one individual, which may pertain to certain circumstances, such as when the user is not the parent of the claimed dependent. The document validation module 21 is also configured to identify discrepancies amongst the one or more text-readable files 61B. If a discrepancy is identified by the document validation module 21, the external communication module 22 is configured to subsequently send a discrepancy alert notification to the user.

The discrepancy alert notification may be configured to be electronically transmitted as a push notification on the mobile device, an email, or a text message. The discrepancy alert notification is configured to identify the certain personal information, such as but not limited to a physical street address, which the document validation module 21 cross-references in two or more of the text-readable files 61B. It is further anticipated that the external communication feature 22 may be configured to not send an electronic facsimile when the document validation module 21 identifies one or more discrepancies related to certain personal information not being disclosed consistently in two or more electronic files uploaded to the remote database 30.

In a nonlimiting, exemplary embodiment of the dissemination system 5 the software application 10 may prompt the user, after uploading electronic copies of two or more documents 60, to enter the physical street address where the user and claimed dependent reside. Upon the user providing such personal information, the document validation module 21 is configured to search for the personal information within two or more text-readable files to confirm whether such personal information is consistently disclosed. It is anticipated that the document validation module 21 could be configured to automatically search a predetermined subset of the one or more text-readable files 61B or allow the user to manually select two or more files to cross-reference.

The external communication module 22 allows the user to send one or more emails or electronic facsimiles (E-Fax) of one or more electronic copies of the one or more documents 60 to one or more other parties. The external communication module 22 allows the user to manually input an email address or fax number as well as select which files to electronically transmit in the email or E-Fax. However, it is anticipated that the external communication module 22 may optionally be configured to automatically provide a phone number, email address, or fax number for the user to call, email, or E-Fax, respectively. The external communication module 22 is further configured to transmit one or more reminder notifications to the user if one or more electronic copies of the one or more documents have not been uploaded by a predetermined date.

The remote database 30 provides an archive 31 to electronically store prior external communication records, which may include email records, electronic facsimiles (E-Fax), or phone calls made from within the mobile application 11 It is further anticipated that phone call transcriptions of phone calls made using the external communication module 22 may be generated and saved within the archive 31. The remote database 30 may be configured to allow the user to also store other electronic files, such as the user's prior tax returns.

The present disclosure is further directed to a method for electronically compiling and transmitting one or more electronic copies 61A, 61B of the one or more documents 60. Accordingly, the method comprises: creating a user account, accessing the user account on the mobile device 50 via the mobile application 11, collecting hard copies of the one or more documents 60 enumerated within the document checklist 20, selecting the document upload feature and utilizing the camera 51 to capture one or more image files 61A of the one or more documents 60 or, alternatively, importing the one or more image files 61A or other types electronic files from the photo library 55, uploading the one or more electronic files 61 to the remote database 30, creating one or more text-readable files 61B from the one or more electronic files 61, selecting the document validation module and validating that certain sensitive personal information, which may include a name or address, contained in each of the one or more text-readable files is consistent, selecting one or more of the one or more electronic files 61 to electrically fax or email via the external communication module 22, electronically transmitting one or more electronic files 61, calling the other party to confirm that the one or more electronic files 61 that were electronically transmitted were received, and automatically storing all records of communication within the archive 31.

While the embodiments of the invention have been disclosed, certain modifications may be made by those skilled in the art to modify the invention without departing from the spirit of the invention.

The inventor claims:

1. A system for dissemination of sensitive information comprising:
a user;
a claimed dependent;
a mobile device;
wherein the mobile device is configured to wireles sly connect to a network;
wherein the mobile device comprises a camera;
a remote database;
wherein the remote database is connected to the network;
one or more documents;
wherein the one or more documents comprise permanent documents and one or more temporary documents;
a software application;
wherein the software application comprises a document checklist, a document validation module, and an external communication module;
wherein the document checklist comprises a predetermined list of one or more documents;
wherein the document checklist is configured to display a visual indicator adjacent to each predetermined document to signify the status of the corresponding document;
wherein the document validation module is configured to cross-reference certain personal information in two or more text-readable files uploaded to the remote database;
wherein the certain personal information comprises a physical street address of the user and the claimed dependent;
wherein the document validation module is configured to generate a discrepancy alert notification if the certain personal information in the two or more text-readable files is inconsistent;
wherein the external communication module is configured to transmit an electronic facsimile of one or more electronic files stored in the remote database;
wherein the external communication module is configured to generate a receipt of delivery confirmation notification; and
wherein the external communication module is configured to send one or more reminder notifications to the user regarding when to upload one or more temporary documents.

2. The system for dissemination of sensitive information of claim 1, wherein the permanent documents comprise a social security card and a birth certificate of both the user and the claimed dependent;

3. The system for dissemination of sensitive information of claim 1, wherein the temporary documents comprise employment records of the claimed dependent.

4. The system for dissemination of sensitive information of claim 1, wherein the temporary documents comprise school records of the claimed dependent.

5. The system for dissemination of sensitive information of claim 1, wherein the temporary documents comprise medical records of the claimed dependent.

6. The system for dissemination of sensitive information of claim 1, wherein the temporary documents comprise records related to the daycare provider of the dependent.

7. The system for dissemination of sensitive information of claim 1, wherein the temporary documents comprise one or more utility bills of the user.

8. The system for dissemination of sensitive information of claim 1, wherein the temporary documents comprise a mortgage note.

9. The system for dissemination of sensitive information of claim 1, wherein the temporary documents comprise a lease agreement.

10. The system for dissemination of sensitive information of claim 1, wherein the temporary documents comprise a letter from a religious institution verifying the user's relationship with the claimed dependent.

11. The system for dissemination of sensitive information of claim 1, wherein the temporary documents comprise a paternity test.

12. The system for dissemination of sensitive information of claim 1, wherein the temporary documents comprise a marriage certificate.

13. The system for dissemination of sensitive information of claim 1, wherein the temporary documents comprise adoption paperwork establishing a relationship between the user and the claimed dependent.

14. The system for dissemination of sensitive information of claim 1, wherein the temporary documents comprise one or more Native American tribal documents.

15. A method of utilizing a system for dissemination of sensitive information wherein the comprises:
creating a user account, accessing the user account on the mobile device via the mobile application;
collecting hard copies of the one or more documents enumerated within the document checklist;
selecting the document upload feature and utilizing the camera to capture one or more image files of the one or more documents;
uploading the one or more electronic files to the remote database;
converting the one or more electronic files into one or more text-readable files;
utilizing the document validation module to cross-reference certain sensitive personal information contained in each of the one or more text-readable files is consistently disclosed;
utilizing the external communication module to select one or more electronic files uploaded to the remote database to be electronically transmitted to another party;
utilizing the external communication module to electronically transmitting one or more electronic files via electronic fax; and
calling the other party to confirm that the electronic fax was received.

16. The method of utilizing a system for dissemination of sensitive information of claim 15, wherein the method further comprises the external communication module automatically storing all records of communication within the archive.
